(19) United States
(12) Patent Application Publication
(10) Pub. No.: US 2022/0131244 A1
(43) Pub. Date: Apr. 28, 2022

(54) Hollow Waveguide Assembly, Waveguide System, and Use of a Hollow Waveguide Assembly

(71) Applicant: Rosenberger Hochfrequenztechnik GmbH & Co. KG, Fridolfing (DE)

(72) Inventors: Florian Westenkirchner, Haiming (DE); Raimund Klapfenberger, Palling (DE)

(21) Appl. No.: 17/441,610

(22) PCT Filed: Mar. 17, 2020
(86) PCT No.: PCT/EP2020/057216

§ 371 Date: Sep. 21, 2021

(30) Foreign Application Priority Data
Mar. 21, 2019 (EP) 19164437.6

(51) Int. Cl. H01P 1/04; H01P 3/12

(52) U.S. Cl. CPC H01P 1/042; H01P 3/12

(57) ABSTRACT

A hollow waveguide assembly having a hollow waveguide body with a first aperture, extending from a first end of the body to a second to end of the body, forming a first hollow waveguide. An outer surface, at the first end of the body, has at least one damping means to suppress propagation of electromagnetic waves on the outer surface. An end face, at the second end of the body, has at least one damping means to suppress propagation of electromagnetic waves on the end face. The hollow waveguide body has a second aperture, extending from the first end of the body to the second end of the body, forming a second hollow waveguide. The at least one damping means suppresses, on the end face, and on the outer surface, propagation of electromagnetic waves from the first hollow waveguide to the second hollow waveguide.

### CROSS REFERENCE TO RELATED APPLICATIONS

This Non-Provisional Patent application is a United States National Stage patent application which claims the benefit of priority to earlier filed PCT Patent Application No. PCT/EP2020/057216, which was filed on 17 Mar. 2020. This United States National Stage patent application also claims the benefit of priority to earlier filed European Patent Application No. 19 164 437.6, which was filed on 21 Mar. 2019. Said earlier filed PCT Patent Application No. PCT/EP20201057216 is published as WO 2020/187881 A1, and was published on 24 Sep. 2020. The entire contents of the aforementioned earlier filed PCT Patent Application and earlier filed European Patent Application are both expressly incorporated herein by this reference.

Pursuant to USPTO rules, this priority claim to earlier filed PCT Patent Application No. PCT/EP2020/057216 filed on 17 Mar. 2020, and to earlier filed European Patent Application No. 19 164 437.6 filed on 21 Mar. 2019, is also included in the Application Data Sheet (ADS) filed herewith.

### TECHNICAL FIELD

The invention relates to a hollow waveguide assembly having a hollow waveguide body.

The invention also relates to a waveguide system comprising a waveguide assembly and a first hollow waveguide assembly having a hollow waveguide body.

The invention relates further to a use of a hollow waveguide assembly.

### BACKGROUND

According to the current prior art, cable-bound data transmission can be divided substantially into two different technologies. Firstly, data transmission by means of metallic conductors and, secondly, optical data transmission by means of glass fibers are known.

As is known, signal transmission via conventional electric conductors, such as copper conductors in electric cables, is subjected to high signal attenuation at high frequencies. Thus, in particular when high requirements are placed on the transmission bandwidth, a great deal of effort consequently has to be expended in order to reach the specifications—if at all possible.

On the other hand, optical data transmission is extremely low-loss and possible with high data rates. However, optical data transmission always requires a conversion of electric signals into optical signals and vice versa, which makes complex transmission and reception structures in this type of signal transmission necessary.

Besides the two conventional data transmission techniques, there is increasing interest in a technology which attempts to establish itself as an alternative. The present invention relates to the data transmission via so-called electromagnetic waveguides, in particular hollow waveguides.

Waveguides of this type are already sufficiently well known in electrical technology, in particular in communications technology and high-frequency technology. In this technology, the electric signal is modulated onto a carrier frequency, in particular in the millimeter wave range (for example 80 GHz), and is transmitted along the waveguide as an electromagnetic wave. As opposed to an optical method, the method manages without an electric-optical conversion. As compared with metallic waveguides, the concept has the advantage of being able to transmit very high data rates. Accordingly, waveguides can advantageously be used when high requirements are placed on the transmission bandwidth and/or on the transmission distance of cable-bound communication.

Although the signal transmission via a waveguide is in principle advantageous, it has transpired in practice that, at waveguide transitions, that is to say at the connecting points of the waveguide to, for example, an antenna assembly or a further waveguide, it is consequently possible for interference at its end face and for electromagnetic radiations to occur, on account of a non-ideal transmission of an electromagnetic wave. In this way, for example, adjacent signal lines, in particular adjacent further waveguides and electronic systems arranged in the vicinity, can be interfered with.

The present invention is based on the object of providing an improved hollow waveguide assembly in which undesired propagation of electromagnetic waves can be avoided or at least suppressed.

The present invention is also based on the object of providing an improved waveguide system in which, in particular, undesired radiation of electromagnetic waves at a waveguide transition can be avoided or at least suppressed.

Furthermore, the invention is based on the object of providing an advantageous use of a hollow waveguide assembly.

The object is achieved for the hollow waveguide assembly by the features of the specification, the Figures and the claims, for the waveguide system by the features of the specification, the Figures and the claims, and for the use by the features of the specification, the Figures and the claims.

The dependent claims and the features described herein relate to advantageous embodiments and variants of the invention.

According to the invention, a hollow waveguide assembly is provided, having a hollow waveguide body with a first aperture extending from a first end of the hollow waveguide body to a second end of the hollow waveguide body to form a first hollow waveguide.

A hollow waveguide in the sense of the present invention is suitable in particular for transmitting an electromagnetic wave along its longitudinal axis or mid-axis.

In the context of the invention, an electromagnetic wave means an electromagnetic wave which does not lie within the light spectrum used for an optical signal transmission.

The invention is in particular suitable for transmitting an electromagnetic wave in the millimeter range (30 GHz to 300 GHz) and sub-millimeter range (300 GHz to 3 THz).

Within the context of the invention, a transmission direction of the electromagnetic wave is unimportant. The electromagnetic wave can thus, for example, be transmitted starting from the first end of the hollow waveguide body to the second end of the hollow waveguide body—or vice versa. In addition, bidirectional and/or dual-polar transmission is possible within the context of the invention. To the extent to which reference is made below to a specific transmission direction of the electromagnetic waves, or to a specific type of transmission, (e.g. type of polarization) of the electromagnetic wave, this is to be attributed only to the simplified description of the invention and not to be understood as restrictive.

As a rule, a hollow waveguide is a tubular structure with a normally rectangular, circular or elliptical cross section. In the present case, the first hollow waveguide (and the further hollow waveguides further described below) is formed by means of the aperture or a recess in the hollow waveguide body.

The hollow waveguide body is preferably a solid body.

According to the invention, an end face formed at the second end of the hollow waveguide body has at least one damping means, which is designed to suppress the propagation of electromagnetic waves on the end face.

In particular, by suppressing the propagation of the electromagnetic wave on the end face of the hollow waveguide body, radiation of the electromagnetic wave, for example starting from the first hollow waveguide, can be suppressed. Advantageously, the crosstalk of signals between different transmission channels of the hollow waveguide assembly (e.g. further hollow waveguides of the hollow waveguide body) can ultimately be prevented or at least reduced.

Within the context of the invention, the term “suppressing” is to be understood to mean a reduction in the propagation of the electromagnetic waves down to complete avoidance of the propagation thereof.

According to the invention, signal decoupling for hollow waveguides, in particular for hollow waveguide bundles, can be provided.

Any desired number of damping means can be provided. For example, only a single damping means can be provided. However, it is also possible for two damping means, three damping means, four damping means, five damping means, six damping means or still more damping means to be provided in order to suppress the propagation of electromagnetic waves on the end face.

The damping means can in particular be designed to configure the surface structure of the end face in such a way that the latter has damping properties.

Preferably, the at least one damping means is designed and arranged to suppress the propagation of electromagnetic waves by destructive interference and/or by lengthening/influencing the path for propagating the electromagnetic wave along the surface.

According to the invention, a plurality of signal transmission channels lying beside one another can be used within a hollow waveguide assembly or within a waveguide system further described below without crosstalk between the individual channels having to be accepted.

In a particularly preferred development of the invention, the invention can optionally provide that an outer surface formed on the first end of the hollow waveguide body has at least one damping means, which is designed to suppress the propagation of electromagnetic waves on the outer surface.

The outer surface is preferably the surface of the hollow waveguide body that faces away from the end face.

The invention can thus provide that a surface adjacent to the first end of the hollow waveguide body also has at least one damping means, which is also designed to suppress the propagation of electromagnetic waves on this surface.

This configuration of the invention has proven to be particularly advantageous since, in particular, crosstalk between multiple channels, as will be described in more detail herein, can be suppressed more intensely if the propagation of the electromagnetic waves on the end face and on the outer surface is suppressed to the same extent.

If, above and below, reference is made to the at least one damping means, these explanations are in principle to be understood to refer to damping means of the end face and/or to damping means of the outer surface.

In principle, still further areas of the lateral surface of the hollow waveguide body can also have damping means according to the invention, for example, therefore, also the side surfaces. At least, however, the end face formed at the second end has the at least one damping means. If, in the following, reference is made only to the end face formed at the second end, this is to be attributed only to the simplified description of the invention and not to be understood as restrictive. The features mentioned can optionally also be transferred to the outer surface adjacent to the first end and/or to one, two, three or four side surfaces of the hollow waveguide body.

In a development of the invention, the invention can optionally provide that the hollow waveguide body has a second aperture extending from the first end of the hollow waveguide body to the second end of the hollow waveguide body to form a second hollow waveguide.

The invention can also provide that the hollow waveguide body also forms still further hollow waveguides in addition to the second hollow waveguide, for example a third hollow waveguide, a fourth hollow waveguide, a fifth hollow waveguide or still more hollow waveguides. For simplified understanding, the invention is described below substantially with two hollow waveguides but this is not to be understood as restrictive. In particular, if, in the context of the description and the patent claims, reference is made to a second hollow waveguide, those skilled in the art can readily widen the respective development within the context of the claimed invention to further hollow waveguides as well.

The invention can also provide that the hollow waveguide assembly, in particular the hollow waveguide body, has still further waveguides of any desired type in addition to the first hollow waveguide, therefore, for example, also dielectric waveguides. The hollow waveguide assembly can thus, for example, have the first hollow waveguide and one or more dielectric waveguides.

The invention can also provide that the hollow waveguide assembly, in particular the hollow waveguide body, has one or more conventional electric signal lines in addition to the first hollow waveguide. The hollow waveguide assembly can thus, for example, have the first hollow waveguide and one or more signal conductors.

In particular if the hollow waveguide assembly has further hollow waveguides, waveguides of any desired type and/or electric conductors in addition to the first hollow waveguide, the respective data transmission can be improved, according to the invention, since the at least one damping means is able to suppress the propagation and therefore the radiation of electromagnetic waves on the end face (and optionally also on the outer surface or on further surfaces) of the hollow waveguide body, and therefore to avoid or at least to reduce crosstalk between the channels.

Preferably, the surface structure between the first hollow waveguide and the second or further hollow waveguides can be configured by the damping means according to the invention in such a way that the undesired propagation of electromagnetic waves between the hollow waveguides is damped.

According to the invention, for example, decoupling of 60 dB and more can be provided on account of the damping by the at least one damping means between the first hollow waveguide and further hollow waveguides, other waveguides or electric conductors.

In a development, provision can optionally be made that the at least one damping means is designed and arranged to suppress the propagation of electromagnetic waves on the end face (and optionally also on the outer surface or on further surfaces), starting from the first hollow waveguide to the second hollow waveguide.

In principle, it may be advantageous to suppress the propagation of electromagnetic waves on the end face or on the outer surface completely. To reduce crosstalk of signals, however, it may already be sufficient to suppress in particular the propagation of the electromagnetic waves starting from the first hollow waveguide to further hollow waveguides, other waveguides or electromagnetic lines.

The requirements and thus also the outlay on production of the hollow waveguide assembly can possibly be reduced if the propagation of the electromagnetic waves does not have to be suppressed on the complete end face or outer surface.

In one refinement of the invention, provision can in particular be made for the hollow waveguide body to be formed from an electrically conductive solid body, preferably from a metal.

The electrically conductive solid body is preferably an electron conductor but can also be an ion conductor.

The hollow waveguide body can also be formed from a conductive polymer, that is to say from a plastic with electrical conductivity. The hollow waveguide body can also be formed from a conductive ceramic, for example from silicon carbide or boron carbide.

In one refinement of the invention, provision can be made that the first aperture and/or the second aperture (and/or further apertures which may possibly be present to form further hollow waveguides) has a round cross section.

In particular, a round hollow waveguide formed by a round aperture, for example a bore, can permit advantageous waveguide transmission, for example also dual-polar waveguide transmission.

In principle, however, the invention can also provide that the first aperture and/or the second aperture (and/or further apertures which may possibly be present to form further hollow waveguides) has a rectangular, elliptical or other cross section. Within the context of the invention, the type of cross section of the aperture is not necessarily important.

The invention can also provide that the first aperture, the second aperture and further apertures which may possibly be present have different cross sections (in particular with regard to diameter and/or geometric shape).

In one development of the invention, the invention can provide that the at least one damping means is designed and arranged to suppress the propagation of electromagnetic waves on the end face (and optionally also on the outer surface or on further surfaces), starting from the first aperture and/or from the second aperture (and/or further apertures which may possibly be present to form further hollow waveguides), completely or at least in a circular section starting from the first aperture and/or from the second aperture (and/or further apertures which may possibly be present to form further hollow waveguides).

Influencing the electromagnetic waves, in particular as close as possible to their output location, that is to say, for example, adjacent to the first hollow waveguide or to the second hollow waveguide, can suppress radiation particularly effectively.

In a development of the invention, the invention can in particular provide that the at least one damping means is arranged running partly or completely annularly around the first aperture and/or is arranged between the first aperture and the second aperture and/or is arranged running partly or completely annularly around the second aperture.

Preferably, at least one damping means is arranged around all apertures extending through the hollow waveguide body to form hollow waveguides, in particular running completely annularly around.

In one development of the invention, the invention can preferably provide that at least one of the damping means is formed as a recess in the end face and/or in the outer surface, in particular as a groove or flute.

The recesses, in particular the grooves or flutes, can preferably be round. However, the invention can also provide that the recesses are rectangular, elliptical or embodied in other ways.

In an alternative or additional development, the invention can provide that at least one of the damping means is formed as an elevation on the end face and/or on the outer surface, in particular as a wall, sleeve or web.

The elevation can in particular be a metallic plate, which extends between two hollow waveguides, for example between the first hollow waveguide and the second hollow waveguide.

The elevation is preferably formed in one piece with the hollow waveguide body but can also be formed from a separate component and electrically conductively connected to the hollow waveguide body. In a two-part configuration, the invention can provide, for example, that the material from which the at least one damping means is formed corresponds to the material of the hollow waveguide body. However, another material can also be provided for forming the damping means, preferably a material with an electric conductivity which corresponds to that of the material of the damping means or is increased with respect to the conductivity of the material of the damping means.

Mixed forms are also possible. For example, the invention can provide that a first damping means is formed as a recess and a second damping means as an elevation.

A refinement of the invention can in particular provide that a first damping means is formed as a first annular groove in the end face and/or in the outer surface, running concentrically around one of the apertures.

A refinement of the invention can provide that the ratio of the depth of the first annular groove to the diameter of the corresponding aperture is 0.2 to 0.6, preferably 0.3 to 0.5 and particularly preferably about 0.4, and/or the ratio of the width of the first annular groove to the diameter of the corresponding aperture is 0.05 to 0.25, preferably 0.1 to 0.2 and particularly preferably about 0.15, and/or the ratio of the radial spacing of the first annular groove from the corresponding aperture to the diameter of the corresponding aperture is 0.05 to 1, preferably 0.1 to 0.5 and particularly preferably about 0.12.

The dimensioning of the damping means, in particular the coordination in depths and spacings of multiple damping means relative to one another, can influence the effectiveness of the invention. Those skilled in the art can choose the dimensions in particular within the context of the above information and preferably depending on the wavelength of the electromagnetic wave to be transmitted. As is known, the diameter of a hollow waveguide can be determined with regard to the wavelength of the electromagnetic wave to be transmitted, Consequently, the size relationships or dimensions of the damping means can result in view of the diameter of the aperture and therefore indirectly as a function of the wavelength.

A refinement of the invention can additionally provide that a second damping means is formed as a second annular groove in the end face and/or in the outer surface, running concentrically around one of the apertures.

The second annular groove preferably extends concentrically about the first annular groove and, starting from a mid-axis of the corresponding aperture, can be arranged radially further out than the first annular groove.

A refinement can provide that the ratio of the depth of the second annular groove to the diameter of the corresponding aperture is 0.1 to 0.5, preferably 0.2 to 0.4 and particularly preferably about 0.3, and/or the ratio of the width of the second annular groove to the diameter of the corresponding aperture is 0.05 to 0.25, preferably 0.1 to 0.2 and particularly preferably about 0.14, and/or the ratio of the radial spacing of the second annular groove from the corresponding aperture to the diameter of the corresponding aperture is 0.05 to 1, preferably 0.3 to 0.7 and particularly preferably about 0.43.

Preferably, the first damping means is deeper than the second damping means. The principle can also be expanded to further damping means, in particular annular grooves, which may be present, wherein, with a concentric arrangement of damping means around one of the apertures, the damping means arranged further out penetrates less deeply into the end face than the damping means arranged closer to the aperture.

Preferably, the first damping means is wider than the second damping means. The principle can also be expanded to further damping means, in particular annular grooves, which may be present, wherein, with a concentric arrangement of damping means around one of the apertures, the damping means located further in can be wider than the damping means located further out.

As already explained, in principle as many damping means as desired can be provided, in particular also running around one of the apertures in a concentric arrangement and formed as an annular groove. For example, a third damping means can be formed as a third annular groove running concentrically around one of the apertures. Furthermore, a fourth damping means can be formed as a fourth annular groove running concentrically around one of the apertures, and so on.

It is to be expected that the damping property can be increased the more damping means are provided around an aperture. At the same time, however, the outlay rises, for which reason those skilled in the art will be able to choose a number of damping means that appears to be suitable or adequate on the basis of the application. Preferably, two damping means are provided per hollow waveguide.

The invention also relates to a waveguide system, comprising a waveguide assembly and a first hollow waveguide assembly having a hollow waveguide body. Between the waveguide assembly and the hollow waveguide body of the first hollow waveguide assembly, a waveguide transition is formed for transmitting an electromagnetic wave between at least one first hollow waveguide of the first hollow waveguide assembly and at least one waveguide of the waveguide assembly.

With regard to the waveguide system, the invention provides for the hollow waveguide body to have at least one damping means on an end face facing the waveguide assembly, which is designed to suppress the propagation of electromagnetic waves on the end face.

If a metallic hollow waveguide ends, interference can propagate over its end face and influence adjacent signal lines. In particular, radiations of electromagnetic waves can occur because of non-ideal waveguide transitions. This radiation can be reduced, according to the invention, which means that electronic systems located in the vicinity are influenced less or not at all.

The invention can in particular be used advantageously to suppress the radiation of electromagnetic waves if the waveguide transition has a gap and the end faces of the first hollow waveguide assembly and the second hollow waveguide assembly thus do not lie ideally on each other.

As a result of the use of the at least one damping means, the propagation of interference signals can be suppressed by means of an adapted geometry of the end face of the hollow waveguide body, and preferably prevented completely.

In one development, the invention can provide that the waveguide assembly is formed as a second hollow waveguide assembly, wherein each of the hollow waveguide assemblies has a first aperture extending from a first end of the hollow waveguide body to a second end of the hollow waveguide body to form a respective first hollow waveguide, and wherein the hollow waveguide assemblies are positioned relative to each other in such a way that their first apertures extend coaxially and the end faces of the respective second ends of the hollow waveguide bodies are opposite each other.

The invention is suitable, in particular, for a waveguide transition between two hollow waveguide assemblies. In principle, however, the invention may also be suitable for suppressing radiation of electromagnetic waves from a waveguide transition between the first hollow waveguide assembly and another type of waveguide assembly, for example a dielectric waveguide assembly.

In one development, the invention can provide that the hollow waveguide body of the second hollow waveguide assembly has at least one damping means on an end face facing the first hollow waveguide assembly, which is designed to suppress the propagation of electromagnetic waves on the end face of the hollow waveguide body of the second hollow waveguide assembly.

It can in particular be advantageous if the first hollow waveguide assembly and the second hollow waveguide assembly each have their own damping means. However, it may already be advantageous and improve the signal transmission if only the first hollow waveguide assembly or the second hollow waveguide assembly has damping means.

In a development, the invention can provide that the hollow waveguide body of the first hollow waveguide assembly and the hollow waveguide body of the second hollow waveguide assembly each have a second aperture extending from the first end of the hollow waveguide body to the second end of the hollow waveguide body to form a respective second hollow waveguide, which extend coaxially with respect to each other.

It is also possible for still further apertures to be provided in the respective hollow waveguide bodies in order to form still further hollow waveguides, which are preferably likewise arranged coaxially.

Within the context of the invention, crosstalk of signals or signal components between the hollow waveguides of the hollow waveguide assemblies can advantageously be suppressed.

A development of the invention can provide that an electric module having an antenna assembly is positioned and aligned relative to the first hollow waveguide assembly in order to introduce the electromagnetic wave starting from the first end of the hollow waveguide body of the first hollow waveguide assembly into the first hollow waveguide and/or into the second hollow waveguide of the first hollow waveguide assembly.

The electric module and the antenna assembly can form a constituent part of the waveguide system.

The antenna assembly can be formed as a patch antenna, Marconi antenna, Vivaldi antenna, dipole antenna or an antenna of another design. In principle, within the context of the invention any desired design of the antenna assembly which appears to be suitable to those skilled in the art can be provided.

The electric module can be, for example, an electric printed circuit board (PCB) or an integrated circuit. It can also be a system-in-package, a multi-chip module and/or a package-on-package.

Preferably, the hollow waveguide body of the first hollow waveguide assembly and/or the second hollow waveguide assembly can have at least one further damping means on an outer surface facing away from the end face, which is designed to suppress the propagation of electromagnetic waves on the outer surface.

A development of the invention can provide that the waveguide assembly and the first hollow waveguide assembly form a plug-in connection.

The invention can in particular be highly suitable for reducing undesired radiation of electromagnetic waves from a waveguide plug-in connection since, in particular in a plug-in connection, because of tolerances during production, mounting or during the use of the plug-in connection, it is not possible to rule out a gap in the waveguide transition, which can promote the radiation of electromagnetic waves. The invention can therefore be used particularly advantageously for plug-in connections.

The invention can in particular relate to signal decoupling for interposers and hollow waveguide bundles for reducing crosstalk.

According to the invention, a hollow waveguide bundle, i.e. a hollow waveguide body which has multiple individual hollow waveguides, can be provided without a high degree of crosstalk between the individual hollow waveguides. In this way, overall space in the signal transmission can be saved.

The invention additionally relates to a use of a hollow waveguide assembly according to the above and following explanations for data transmission by means of electromagnetic waves.

The hollow waveguide assembly according to the invention can advantageously be provided to form board-to-board connections or chip-to-chip connections and, as a result, in particular replace optical systems.

However, the use of the hollow waveguide assembly according to the invention is not advantageous only during data transmission but can also be used in other regions such as, for example, (high-frequency) measurement technology. The invention is thus not to be understood as a specific and exclusive solution relating to improved data transmission.

The hollow waveguide assembly according to the invention, or the waveguide system according to the invention, can advantageously be used within the whole of electrical technology, thus, for example, in radar technology or in antenna technology. A preferred area of application, however, relates to space travel technology and vehicle technology (land-based vehicles, watercraft and aircraft). Particularly preferably, high-frequency electromagnetic signals can be transmitted at high data rates between control devices of vehicles, for example motor vehicles.

The hollow waveguide assembly according to the invention and the waveguide system according to the invention can be provided for the transmission of electromagnetic waves having any desired type of polarization, in particular linear or circular.

Features which have already been described in conjunction with the hollow waveguide assembly according to the invention can of course also advantageously be implemented for the waveguide system according to the invention or for the use described—and vice versa. Furthermore, advantages which have already been recited in conjunction with the hollow waveguide assembly according to the invention can also be understood to be based on the waveguide system according to the invention and on the use—and vice versa.

In addition, it should be pointed out that terms such as “comprising”, “having” or “with” do not rule out other or further/additional features or steps. Furthermore, terms such as “a” or “the” which point to a single number of steps or features do not rule out a multiplicity of steps or features—and vice versa.

Exemplary embodiments of the invention will be explained in more detail below with reference to the accompanying Figures/Drawings.

The Figures each show preferred exemplary embodiments, in which individual features of the present invention are illustrated in combination with one another. Features of one exemplary embodiment can also be implemented separately from the other features of the same exemplary embodiment and can accordingly readily be connected by those skilled in the art to form further expedient combinations and sub-combinations with features of other exemplary embodiments.

### SUMMARY

A principal aspect of the present invention is a hollow waveguide assembly (1), having a hollow waveguide body (2) with a first aperture (3) extending from a first end (2.1) of the hollow waveguide body (2) to a second end (2.2) of the hollow waveguide body (2) to form a first hollow waveguide (4), wherein an outer surface (19) formed on the first end (2.1) of the hollow waveguide body (2) has at least one damping means (8, 9, 10, 21), which is designed to suppress the propagation of electromagnetic waves on the outer surface (19), and wherein an end face (7) formed on the second end (2.2) of the hollow waveguide body (2) has at least one damping means (8, 9, 10, 21) which is designed to suppress the propagation of electromagnetic waves on the end face (7), characterized in that the hollow waveguide body (2) has a second aperture (5) extending from the first end (2.1) of the hollow waveguide body (2) to the second end (2.2) of the hollow waveguide body (2) to form a second hollow waveguide (6), wherein the at least one damping means (8, 9, 10, 21) is designed and arranged to suppress the propagation of electromagnetic waves on the end face (7) and on the outer surface (19), starting from the first hollow waveguide (4) to the second hollow waveguide (6).

A further aspect of the present invention is a hollow waveguide assembly (1), characterized in that the at least one damping means (8, 9, 10, 21) is designed and arranged to suppress the propagation of electromagnetic waves on the end face (7) and on the outer surface (19), starting from the first aperture (3) and/or from the second aperture (5), completely or at least in a circular section starting from the first aperture (3) and/or from the second aperture (5).

A further aspect of the present invention is a hollow waveguide assembly (1), characterized in that the at least one damping means (8, 9, 10, 21) is arranged running partly or completely annularly around the first aperture (3) and/or is arranged between the first aperture (3) and the second aperture (5) and/or is arranged running partly or completely annularly around the second aperture (5).

A further aspect of the present invention is a hollow waveguide assembly (1), characterized in that the at least one of the damping means is formed as a recess in the end face (7) or in the outer surface (19), in particular as a groove (8, 9) or flute.

A further aspect of the present invention is a hollow waveguide assembly (1), characterized in that the at least one of the damping means is formed as an elevation on the end face (7) or on the outer surface (19), in particular as a wall (10), sleeve (21) or web.

A further aspect of the present invention is a waveguide system (11), comprising a waveguide assembly (12) and a first hollow waveguide assembly (1) having a hollow waveguide body (2), wherein, between the waveguide assembly (12) and the hollow waveguide body (2) of the first hollow waveguide assembly (1), a waveguide transition (13) is formed for transmitting an electromagnetic wave (14) between at least one first hollow waveguide (4) of the first hollow waveguide assembly (1) and at least one waveguide (4′) of the waveguide assembly (12), characterized in that the hollow waveguide body (2) has at least one damping means (8, 9, 10, 21) on an end face (7) facing the waveguide assembly (12), which is designed to suppress the propagation of electromagnetic waves on the end face (7).

A further aspect of the present invention is a waveguide system (11), characterized in that the waveguide assembly is formed as a second hollow waveguide assembly (12), wherein each of the hollow waveguide assemblies (1, 12) has a first aperture (3, 3′) extending from a first end (2.1, 2.1′) of the hollow waveguide body (2, 2′) to a second end (2.2, 2.2′) of the hollow waveguide body (2, 2′) to form a respective first hollow waveguide (4, 4′), and wherein the hollow waveguide assemblies (1, 12) are positioned relative to each other in such a way that their first apertures (3, 3′) extend coaxially and the end faces (7, 7′) of the respective second ends (2.2, 2.2′) of the hollow waveguide bodies (2, 2′) are opposite each other.

A further aspect of the present invention is a waveguide system (11), characterized in that the hollow waveguide body (2′) of the second hollow waveguide assembly (12) has at least one damping means (8′, 9′, 10) on an end face (7′) facing the first hollow waveguide assembly (1), which is designed to suppress the propagation of electromagnetic waves on the end face (7′) of the hollow waveguide body (2′) of the second hollow waveguide assembly (12).

A further aspect of the present invention is a waveguide system (11), characterized in that the hollow waveguide body (2) of the first hollow waveguide assembly (1) and the hollow waveguide body (2′) of the second hollow waveguide assembly (12) each have a second aperture (5, 5′) extending from the first end (2.1, 2.1′) of the hollow waveguide body (2, 2′) to the second end (2.2, 2.2′) of the hollow waveguide body (2, 2′) to form a respective second hollow waveguide (6, 6′), which extend coaxially with respect to each other.

A further aspect of the present invention is a waveguide system (11), characterized in that an electric module (15) having an antenna assembly (16) is positioned and aligned relative to the first hollow waveguide assembly (1) in order to introduce the electromagnetic wave (14) starting from the first end (2.1) of the hollow waveguide body (2) of the first hollow waveguide assembly (1) into the first hollow waveguide (4) and/or into the second hollow waveguide (6) of the first hollow waveguide assembly (1).

A still further aspect of the present invention is a waveguide system (11), characterized in that the waveguide assembly (12) and the first hollow waveguide assembly (1) form a plug-in connection.

An even still further aspect of the present invention is a use of a hollow waveguide assembly (1) for data transmission by means of electromagnetic waves.

These and other aspects of the present invention are disclosed herein.

### BRIEF DESCRIPTIONS OF THE DRAWINGS

In the Figures, functionally identical elements are provided with the same designations.

In the Figures, schematically:

FIG. 1 shows a hollow waveguide assembly according to the invention having a first hollow waveguide and a second hollow waveguide in a perspective view.

FIG. 2 shows a top view of the hollow waveguide assembly of FIG. 1

FIG. 3 shows an isometric longitudinal section view of the hollow waveguide assembly of FIG. 1 taken on section line III-III of FIG. 1;

FIG. 4 shows a detail view of the sectional illustration of the first hollow waveguide of FIG. 3;

FIG. 5 shows a hollow waveguide system according to the invention having a first hollow waveguide assembly and a second hollow waveguide assembly in a perspective sectional illustration.

FIG. 6 shows a waveguide system according to the invention having an electric module and an antenna assembly in a sectional illustration.

FIG. 7 shows a second exemplary embodiment of a hollow waveguide assembly according to the invention having a first hollow waveguide and a second hollow waveguide in a perspective sectional illustration.

FIG. 8 shows a second exemplary embodiment of a waveguide system according to the invention having a first hollow waveguide assembly and a second hollow waveguide assembly in a perspective sectional illustration.

FIG. 9 shows a third exemplary embodiment of a hollow waveguide assembly according to the invention having a first hollow waveguide and a second hollow waveguide in a perspective sectional illustration.

FIG. 10 shows a third exemplary embodiment of a waveguide system according to the invention having a first hollow waveguide assembly and a second hollow waveguide assembly in a perspective sectional illustration.

FIG. 11 shows a fourth exemplary embodiment of a hollow waveguide assembly according to the invention having a first hollow waveguide and a second hollow waveguide in a perspective sectional illustration.

FIG. 12 shows a fourth exemplary embodiment of a waveguide system according to the invention having a first hollow waveguide assembly and a second hollow waveguide assembly in a perspective sectional illustration.

FIG. 13 shows a fifth exemplary embodiment of a hollow waveguide assembly according to the invention having a first hollow waveguide and a second hollow waveguide in a perspective sectional illustration.

FIG. 14 shows a sixth exemplary embodiment of a hollow waveguide assembly according to the invention having a first hollow waveguide and a second hollow waveguide in a perspective sectional illustration.

FIG. 15 shows a seventh exemplary embodiment of a hollow waveguide assembly according to the invention having a first hollow waveguide and a second hollow waveguide in a perspective view.

FIG. 16 shows simulation results of the decoupling of a waveguide transition according to the prior art for various gap dimensions.

FIG. 17 shows simulation results of the decoupling of a waveguide system according to the invention for various gap dimensions.

### DETAILED WRITTEN DESCRIPTION OF THE PREFERRED EMBODIMENTS

This disclosure of the invention is submitted in furtherance of the Constitutional purposes of the US Patent Laws, “to promote the progress of science and useful arts” (Article 1, Section 8).

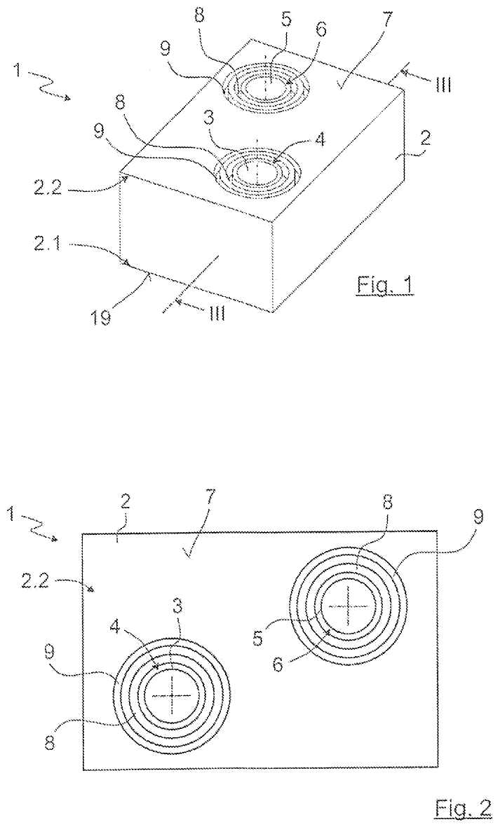

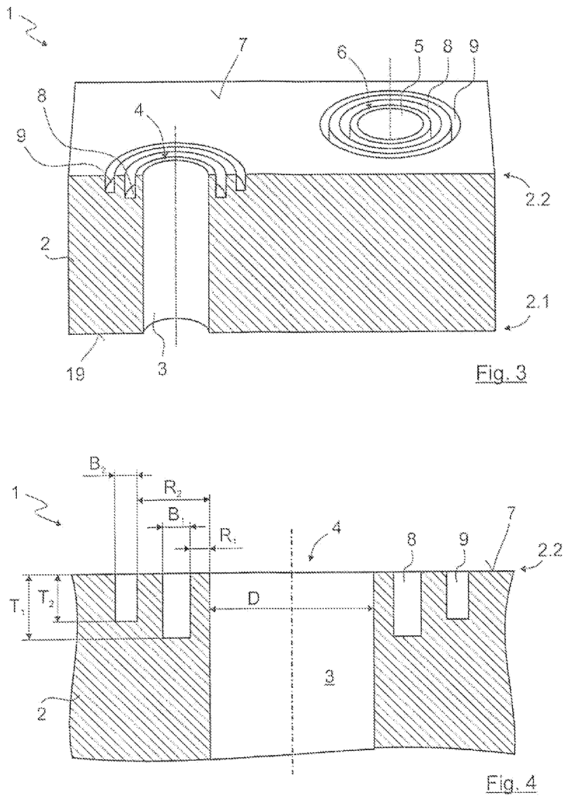

FIG. 1 shows a hollow waveguide assembly 1 according to the invention according to a first exemplary embodiment in a perspective view. For improved clarity, FIG. 2 additionally shows a top view of the hollow waveguide assembly 1 from FIG. 1, and FIG. 3 shows an isometric sectional illustration according to section line III-III from FIG. 1.

The hollow waveguide assembly 1 has a hollow waveguide body 2 with a first aperture 3 extending from a first end 2.1 of the hollow waveguide body 2 to a second end 2.2 of the hollow waveguide body 2 to form a first hollow waveguide 4. The hollow waveguide body 2 illustrated is formed from a solid body, which is preferably an electrically conductive solid body, in particular a metal.

In the exemplary embodiment, a second aperture 5 is also provided, which likewise extends from the first end 2.1 of the hollow waveguide body 2 to the second end 2.2 of the hollow waveguide body 2 and forms a second hollow waveguide 6. In principle, more than the two hollow waveguides 4, 6 can also be provided, for example three, four, five or still more hollow waveguides, which are formed by corresponding apertures in the hollow waveguide body 2. The additional hollow waveguides can also be omitted, however; within the context of the invention, at least one of the first hollow waveguides 4 is therefore provided.

According to the invention, the end face 7 formed at or adjacent to the second end 2.2 of the hollow waveguide body 2 has at least one damping means 8, 9, 10, 21, which is designed to suppress the propagation of electromagnetic waves on the end face 7. In the exemplary embodiment, the at least one damping means 8, 9, 10, 21 is designed and arranged to suppress the propagation of electromagnetic waves on the end face 7 starting from the first hollow waveguide 4 to the second hollow waveguide 6—and vice versa.

The first aperture 3 and the second aperture 5 have a round cross section in the exemplary embodiments. In principle, however, any desired cross section can be provided, for example also a rectangular or elliptical cross section. The first aperture 3, the second aperture 5 and further apertures which may be present can differ with regard to their cross section and can preferably be determined as a function of the wavelength of the electromagnetic wave. In the exemplary embodiments, the cross sections of the two apertures 3, 5 are formed identically for simplification.

Preferably, the at least one damping means 8, 9 is designed and arranged to completely suppress the propagation of electromagnetic waves on the end face 7 starting from the first aperture 3 and/or from the second aperture 5. This is the case in the exemplary embodiments according to FIGS. 1 to 6 and 9 to 14. However, provision can also be made that the at least one damping means is designed and arranged to suppress the propagation of electromagnetic waves on the end face 7 in some sections or some regions, for example in a circular section starting from the first aperture 3 and/or from the second aperture 5.

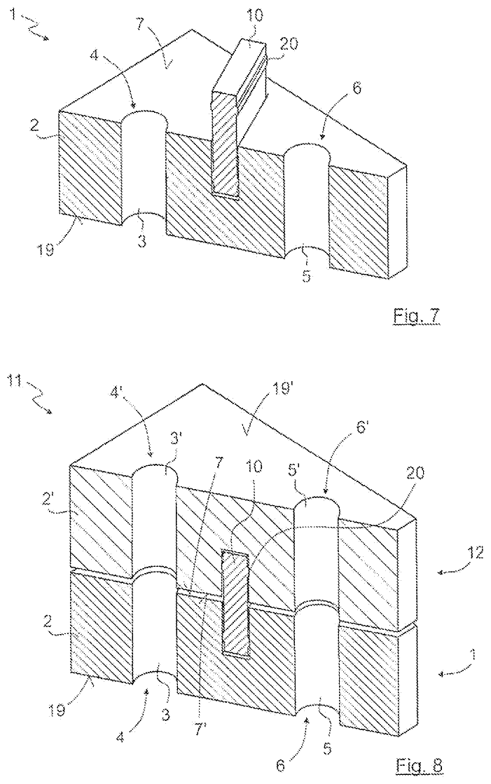

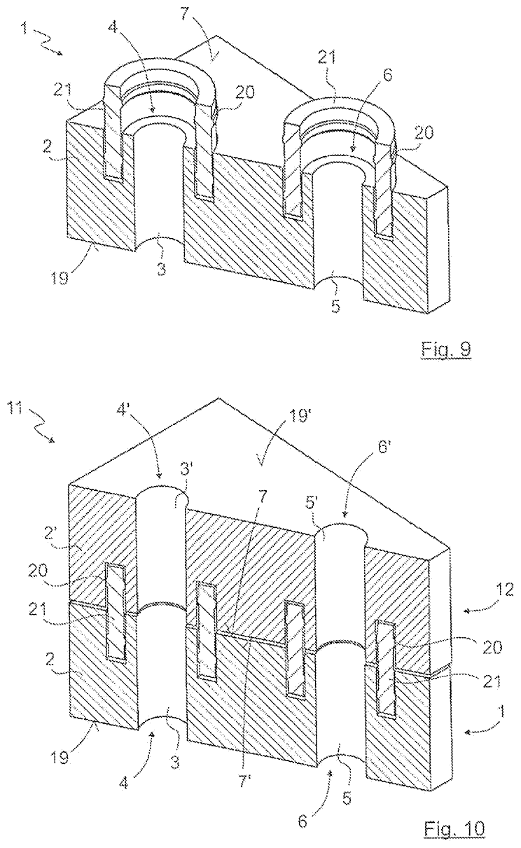

The at least one damping means (8, 9, 10, 21) can preferably be formed as a recess in the end face 7, in particular as a groove 8, 9 or flute. Alternatively, the at least one damping means (8, 9, 10, 21) can also be formed as an elevation on the end face 7, in particular as a wall 10 or web (cf. FIGS. 7, 8 and 15 further described below). In addition, a configuration as a sleeve 21 (cf. FIGS. 9 to 12) can be advantageous.

In the exemplary embodiment of the hollow waveguide assembly 1 shown in FIGS. 1 to 4, in each case two damping means 8, 9 are provided for each aperture 3, 5. A first damping means is formed as a first annular groove 8 running concentrically around the corresponding aperture 3, 5, and a second damping means is formed as a second annular groove 9 running concentrically around the corresponding aperture 3, 5. In principle, still further annular grooves can also be provided, for example a third annular groove, a fourth annular groove, a fifth annular groove or still more annular grooves.

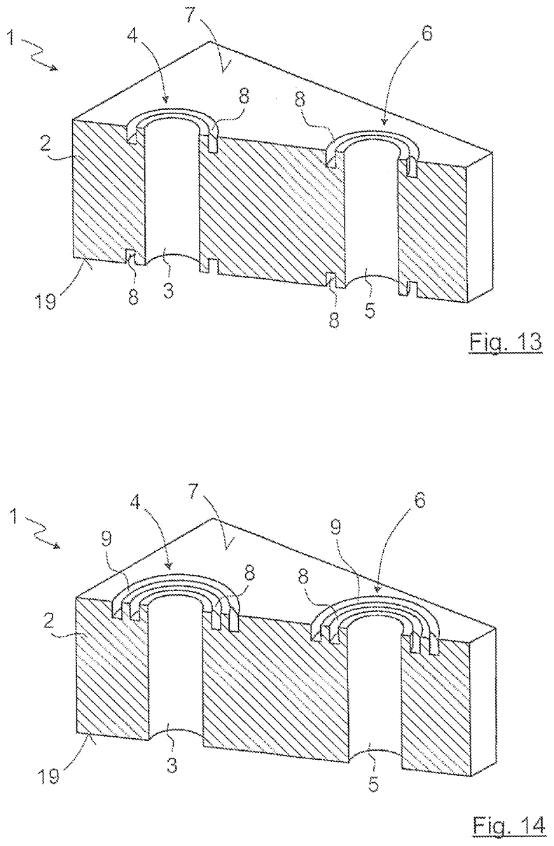

It is also possible for only a single annular groove to be provided for each aperture (cf. FIG. 13) or else only one damping starting from one of the apertures 3, 5. Preferably, the damping means or the annular grooves 8, 9 are arranged running completely annularly around the apertures 3, 5 associated therewith. If appropriate, however, it may also be sufficient if the damping means or annular grooves 8, 9 run around only partially annularly, for example in order to suppress the propagation of electromagnetic waves only along a circular section.

The effectiveness of the suppression or the damping can be influenced by the size relationships of the damping means 8, 9, 10, 21 and the apertures 3, 5, in particular with regard to the wavelength of the electromagnetic waves to be transmitted. The relative size relationships shown in FIGS. 1 to 4 correspond approximately to a preferred embodiment.

The relationships and size relationships can be seen particularly well from FIG. 4. The ratio of the depth T₁ of the first annular groove 8 to the diameter D of the corresponding aperture 3, 5 can be 0.2 to 0.6, preferably 0.3 to 0.5 and particularly preferably about 0.4. Furthermore, the ratio B₁ of the first annular groove 8 to the diameter D of the corresponding aperture 3, 5 can be 0.05 to 0.25, preferably 0.1 to 0.2 and particularly preferably about 0.15. Finally, the ratio of the radial spacing R₁ of the first annular groove 8 from the corresponding aperture 3, 5 to the diameter D of the corresponding aperture 3, 5 can be 0.05 to 1, preferably 0.1 to 0.5 and particularly preferably about 0.12.

The ratio of the depth T₂ of the second annular groove 9 to the diameter D of the corresponding aperture 3, 5 can be 0.1 to 0.5, preferably 0.2 to 0.4 and particularly preferably about 0.3. The ratio of the width B₂ of the second annular groove 9 to the diameter D of the corresponding aperture 3, 5 can be 0.05 to 0.25, preferably 0.1 to 0.2 and particularly preferably about 0.14. Finally, the ratio of the radial spacing R₂ of the second annular groove 9 from the corresponding aperture 3, 5 to the diameter D of the corresponding aperture 3, 5 can be 0.05 to 1, preferably 0.3 to 0.7 and particularly preferably about 0.43, as illustrated.

It should be emphasized that all the above size specifications can also be singled out separately or in any desired combinations and be advantageous.

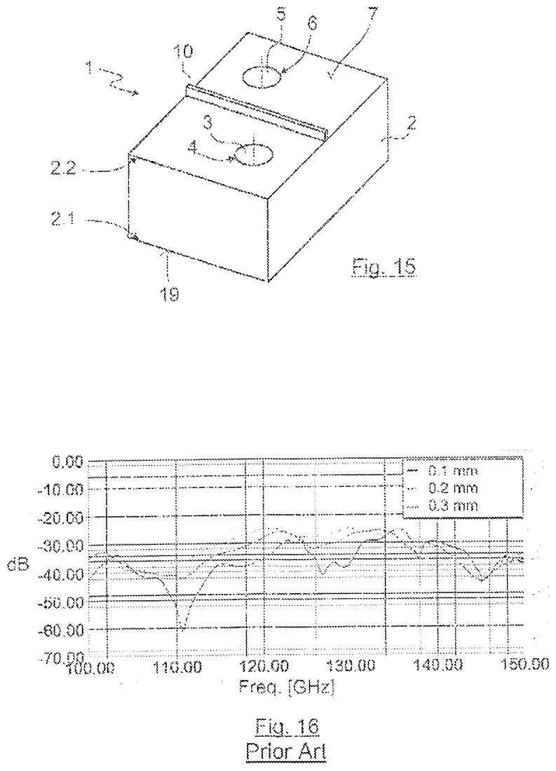

A configuration of the invention in which multiple annular grooves have the same depth can also be advantageous, as illustrated by way of example by using FIG. 14.

In a particularly preferred, but optional refinement of the invention, provision can be made that an outer surface 19 formed on the first end 2.1 of the hollow waveguide body 2 has at least one further damping means 8, 9, 10, 21, which is designed to suppress the propagation of electromagnetic waves on the outer surface 19. For simplification, this is merely illustrated by way of example in FIG. 13. In principle, damping means 8, 9, 10, 21 can be provided on the outer surface 19 for each of the exemplary embodiments mentioned above and below, or combinations and variants of these exemplary embodiments.

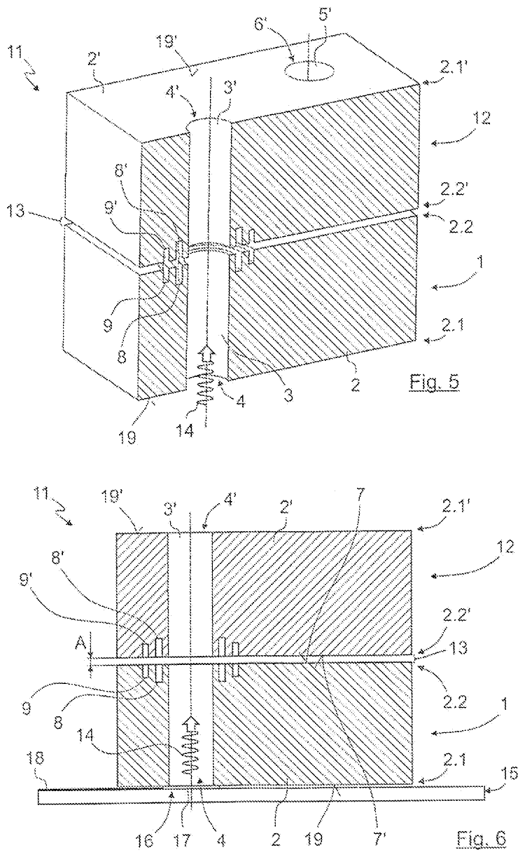

An exemplary waveguide system 11 according to the invention is shown in FIG. 5 in an isometric sectional illustration. FIG. 5 shows a waveguide system 11 comprising a waveguide assembly 12 and a first hollow waveguide assembly 1 having a hollow waveguide body 2, wherein, between the waveguide assembly 12 and the hollow waveguide body 2 of the first hollow waveguide assembly 1, a waveguide transition 13 for transmitting an electromagnetic wave 14 between at least one first hollow waveguide 4 of the first hollow waveguide assembly 1 and at least one waveguide 4′ of the waveguide assembly 12 is formed.

The waveguide assembly 12 in the exemplary embodiment is formed as a second hollow waveguide assembly 12, wherein each of the hollow waveguide assemblies 1, 12 has a first aperture 3, 3′ extending from a first end 2.1, 2.1′ of the hollow waveguide body 2, 2′ to a second end 2.2, 2.2′ of the hollow waveguide body 2, 2′ to form a respective first hollow waveguide 4, 4′, and wherein the hollow waveguide assemblies 1, 12 are positioned relative to each other in such a way that their first apertures 3, 3′ extend coaxially and the end faces 7, 7′ of the respective second ends 2.2, 2.2′ of the hollow waveguide bodies 2, 2′ are opposite each other.

According to the invention, at least the hollow waveguide body 2 of the first hollow waveguide assembly 1 has at least one damping means (in the present case, by way of example, the two annular grooves 8, 9) on an end face 7 facing the waveguide assembly or the second hollow waveguide assembly 12, which is designed to suppress the propagation of electromagnetic waves on the end face 7.

In the exemplary embodiment, the hollow waveguide body 2′ of the second hollow waveguide assembly 12 likewise has at least one damping means (in the present case, however, two concentric annular grooves 8′, 9′) on an end face 7′ facing the first hollow waveguide assembly 1, which is designed to suppress the propagation of electromagnetic waves on the end face 7′ of the second end 2.2′ of the hollow waveguide body 2′ of the second hollow waveguide assembly 12.

In addition, the outer surfaces 19, 19′ of the first hollow waveguide assembly 1 and/or the second hollow waveguide assembly 12 can optionally have damping means 8, 9, 10, 21.

Any desired combinations of damping means 8, 9, 10, 21 with regard to the apertures 3, 5, the end faces 7, 7′ and the outer surfaces 19, 19′ are possible.

The hollow waveguide body 2 of the first hollow waveguide assembly 1 and the hollow waveguide body 2′ of the second hollow waveguide assembly 12 each have a second aperture 5, 5′ extending from the first end 2.1, 2.1′ of the hollow waveguide body 2, 2′ to the second end 2.2, 2.2′ of the hollow waveguide body 2, 2′ to form a respective second hollow waveguide 6, 6′, which likewise extend coaxially with respect to each other.

According to the invention, with regard to the waveguide system 11 illustrated, because of the use of the damping means 8, 9, 8′, 9′, 10, 21, crosstalk between the channels and the hollow waveguides 4, 6, 4′, 6′ of the respective hollow waveguide assemblies 1, 12 can be suppressed, preferably completely avoided.

In FIG. 6, the waveguide system 11 of FIG. 5 is expanded by an electric module 15 having an antenna assembly 16. The electric module 15 can be formed, for example, as an electric printed circuit board (PCB) and with the antenna assembly 16 positioned and aligned relative to the first hollow waveguide assembly 1 in such a way that the electromagnetic wave 14 starting from the first end 2.1 of the hollow waveguide body 2 of the first hollow waveguide assembly 1 can be introduced into the first hollow waveguide 4. The antenna assembly 16 can be, for example, a patch antenna 17, which is fed by a microstrip line 18.

The waveguide assembly or the second hollow waveguide assembly 12 and the first hollow waveguide assembly 1 can, for example, form a plug-in connection. Here, a distance A can remain in the region of the waveguide transition 13, in particular as a result of tolerances, even if the plug-in connection is made. According to the prior art, the distance-induced radiation of electromagnetic waves because of the propagation of the electromagnetic waves on the end faces 7, 7′ can lead to crosstalk between the transmission channels.

Instead of the damping means illustrated as annular grooves 8, 9, 8′, 9′, within the context of the waveguide system 11 or else the individual hollow waveguide assemblies 1, 12, any desired variants for forming the damping means can be implemented, combinations also being possible. This is to be illustrated in the following FIGS. 7 to 15.

FIG. 7 illustrates an exemplary alternative to the damping means formed as annular grooves 8, 9 according to the exemplary embodiment of FIG. 1. FIG. 7 shows a variant of the invention, according to which the at least one damping means is formed as an elevation on the end face 7. For this purpose, a wall 10 is formed on the end face 7, between the first aperture 3 and the second aperture 5, in order to suppress the propagation of electromagnetic waves on the end face 7 between the first aperture 3 and the second aperture 5. FIG. 8 shows an appropriately equipped waveguide system 11.

The wall 10 or the damping means is formed as a separate component in the exemplary embodiments and inserted into appropriate recesses but can also be formed in one piece with the first hollow waveguide body 1 or with the second hollow waveguide body 12. For a suitable mechanical and electrical contact of the wall 10 with the first hollow waveguide assembly 1 and/or the second hollow waveguide assembly 12, use can be made of the webs 20 illustrated, which, for example, can permit a press fit.

A further example of a wall 10 is illustrated schematically in FIG. 15. For example, provision can be made that the first hollow waveguide assembly 1 has at least one damping means formed as an elevation on the end face 7, in particular the wall 10. The waveguide assembly or the second hollow waveguide assembly 12 can then preferably have a damping means formed as a groove, into which the wall 10 can penetrate when the waveguide transition 13 is formed or the first hollow waveguide assembly 1 and the waveguide assembly or second hollow waveguide assembly 12 are brought close to each other.

It may be advantageous to arrange the wall 10 centrally between the apertures 3, 5 and preferably symmetrically between the apertures 3, 5.

Within the context of the invention, a plurality of walls can also be provided.

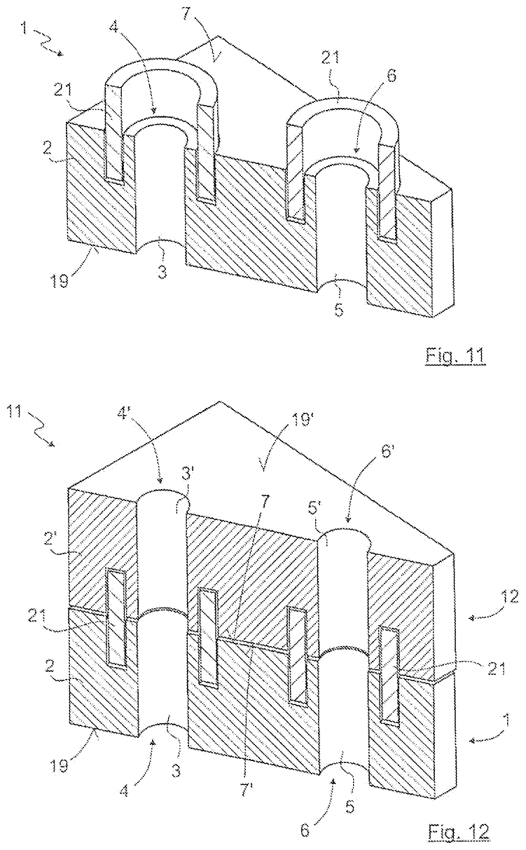

The wall or walls can also be arranged running annularly around at least one of the apertures 3, 5 (completely or partly), similarly or inversely to the arrangement of the annular grooves 8, 9. Exemplary damping means formed as sleeves 21 are illustrated in FIGS. 9 and 10 (with webs 20 for a press fit) and in FIGS. 11 and 12 (with a simplified design without webs).

Combinations of walls 10, sleeves 21 and annular grooves 8, 9 can also be provided.

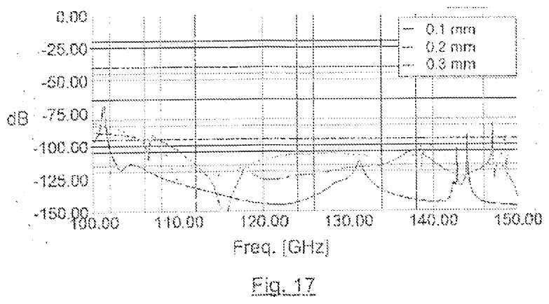

To illustrate the advantages of the claimed invention, FIGS. 16 and 17 show simulation results of waveguide assemblies 11 having various gap dimensions (0.1 mm/0.2 mm/0.3 mm). FIG. 16 shows decoupling between two channels according to the prior art, and FIG. 17 shows decoupling according to the invention with the described damping means 8, 9, 8′, 9′ according to the illustrations of FIGS. 1 to 6.

### Operation

A principal object of the present invention is a hollow waveguide assembly (1) comprising: a hollow waveguide body (2) defining a first aperture (3) extending from a first end (2.1) of the hollow waveguide body (2) to a second end (2.2) of the hollow waveguide body (2) to form a first hollow waveguide (4), and wherein an outer surface (19) on the first end (2.1) of the hollow waveguide body (2) has at least one damping means (8, 9, 10, 21), to suppress propagation of electromagnetic waves on the outer surface (19); and wherein an end face (7) on the second end (2.2) of the hollow waveguide body (2) has at least one damping means (8, 9, 10, 21) to suppress propagation of electromagnetic waves on the end face (7); and wherein the hollow waveguide body (2) defines a second aperture (5) that extends from the first end (2.1) of the hollow waveguide body (2) to the second end (2.2) of the hollow waveguide body (2) to form a second hollow waveguide (6); and wherein the at least one damping means (8, 9, 10, 21) is designed and arranged to suppress propagation of electromagnetic waves on the end face (7) and on the outer surface (19), starting from the first hollow waveguide (4) to the second hollow waveguide (6).

A further object of the present invention is a hollow waveguide assembly (1) wherein the at least one damping means (8, 9, 10, 21) suppresses propagation of electromagnetic waves on the end face, (7) and on the outer surface (19) completely starting from the first aperture (3) and/or from the second aperture (5).

A further object of the present invention is a hollow waveguide assembly (1) wherein the at least one damping means (8, 9, 10, 21) is arranged running partly annularly, or completely annularly, around at least one of the apertures (3, 5).

A further object of the present invention is a hollow waveguide assembly (1) wherein the at least one of the damping means (8, 9, 10, 21) is formed as a recess defined in the end face (7) or in the outer surface (19).

A further object of the present invention is a hollow waveguide assembly (1) wherein the at least one of the damping means (8, 9, 10, 21) is an elevation on the end face (7) or an elevation on the outer surface (19).

A further object of the present invention is a waveguide system (11), comprising: a waveguide assembly (12); and a first hollow waveguide assembly (1), that has a hollow waveguide body (2); and a waveguide transition (13) between the waveguide assembly and the hollow waveguide body (2) of the first hollow waveguide assembly, and the waveguide transition is for transmitting an electromagnetic wave (14) between at least one first hollow waveguide (4) of the first hollow waveguide assembly (1) and at least one waveguide (4′) of the waveguide assembly (12), and wherein the hollow waveguide body (2) has at least one damping means (8, 9, 10, 21) on an end face (7) facing the waveguide assembly (12), which suppresses propagation of electromagnetic waves on the end face (7).

A further object of the present invention is a waveguide system (11) wherein the waveguide assembly is a second hollow waveguide assembly (12) that has a hollow waveguide body, and wherein each of the second hollow waveguide assembly, and the first hollow waveguide assembly, (1, 12) defines a first aperture (3, 3′) that extends from a first end (2.1, 2.1′) of the respective hollow waveguide body (2, 2′) to a second end (2.2, 2.2′) of the respective hollow waveguide body (2, 2′) to form a respective first hollow waveguide (4, 4′), and wherein the second hollow waveguide assembly and the first hollow waveguide assembly (1, 12) are positioned relative to one another in such a way that their the respective first apertures (3, 3′) extend coaxially and the end faces (7, 7′) of the respective second ends (2.2, 2.2′) of the respective hollow waveguide bodies (2, 2′) are opposite one another.

A further object of the present invention is a waveguide system (11) wherein the hollow waveguide body (2′) of the second hollow waveguide assembly (12) has at least one damping means (8′, 9′, 10) on an end face of the hollow waveguide body (7′) facing the first hollow waveguide assembly (1) to suppress propagation of electromagnetic waves on the end face (7′) of the hollow waveguide body (2′) of the second hollow waveguide assembly (12).

A further object of the present invention is a waveguide system (11) wherein the hollow waveguide body (2) of the first hollow waveguide assembly (1) and the hollow waveguide body (2′) of the second hollow waveguide assembly (12) each define a second aperture (5, 5′) and each second aperture extends from the first end (2.1, 2.1′) of the respective hollow waveguide body (2, 2′) to the second end (2.2, 2.2′) of the respective hollow waveguide body (2, 2′) to form a respective second hollow waveguide (6, 6′), which extend coaxially with respect to each other.

A further object of the present invention is a waveguide system (11) and further comprising: an electric module (15) that has an antenna assembly (16) positioned and aligned relative to the first hollow waveguide assembly (1) to introduce the electromagnetic wave into at least one of the first hollow waveguide and/or second hollow waveguide of the first hollow waveguide assembly (1) starting from the first end (2.1) of the hollow waveguide body (2) of the first hollow waveguide assembly (1).

A further object of the present invention is a waveguide system (11) wherein the waveguide assembly (12) and the first hollow waveguide assembly (1) form a plug-in connection.

A further object of the present invention is a method for data transmission comprising the steps: providing a hollow waveguide assembly (1), the hollow waveguide assembly (1) having a hollow waveguide body (2) defining a first aperture (3) extending from a first end (2.1) of the hollow waveguide body (2) to a second end (2.2) of the hollow waveguide body (2) to form a first hollow waveguide (4), and wherein the hollow waveguide body (2) defines a second aperture (5) that extends from the first end (2.1) of the hollow waveguide body (2) to the second end (2.2) of the hollow waveguide body (2) to form a second hollow waveguide (6); and wherein an outer surface (19) on the first end (2.1) of the hollow waveguide body (2) has at least one damping means (8, 9, 10, 21) to suppress propagation of electromagnetic waves on the outer surface (19); and wherein an end face (7) on the second end (2.2) of the hollow waveguide body (2) has at least one damping means (8, 9, 10, 21) to suppress propagation of electromagnetic waves on the end face (7); and wherein the at least one damping means (8, 9, 10, 21) is arranged to extend, at least one of, Partly annularly or completely annularly, around at least one aperture (3, 5); and wherein the at least one of the damping means (8, 9, 10, 21) is formed of, at least one of, a recess and/or an elevation defined in at least one of the end face (7) or in the outer surface (19); and introducing an electromagnetic wave for transmitting the data into a hollow waveguide defined in the hollow waveguide body (2).

A further object of the present invention is a hollow waveguide assembly (1) wherein the at least one damping means (8, 9, 10, 21) suppresses propagation of electromagnetic waves on the end face (7), and on the outer surface (19), at least in a circular section, starting from the first aperture (3) and/or from the second aperture (5).

A further object of the present invention is a hollow waveguide assembly (1) wherein the at least one damping means (8, 9, 10, 21) is arranged between the first aperture (3) and the second aperture (5).

A still further object of the present invention is a hollow waveguide assembly (1) wherein the at least one of the damping means (8, 9, 10, 21) is at least one of a groove or a flute (8, 9).

An even still further object of the present invention is a hollow waveguide assembly (1) wherein the at least one of the damping means (8, 9, 10, 21) is at least one of a wall, a sleeve, or a web (10, 21).

In compliance with the statute, the present invention has been described in language more or less specific, as to structural and methodical features. It is to be understood, however, that the invention is not limited to the specific features shown and described since the means herein disclosed comprise preferred forms of putting the invention into effect. The invention is, therefore, claimed in any of its forms or modifications within the proper scope of the appended claims appropriately interpreted in accordance with the Doctrine of Equivalents.

1. A hollow waveguide assembly raving comprising:
a hollow waveguide body defining a first aperture extending from a first end of the hollow waveguide body to a second end of the hollow waveguide body to form a first hollow waveguide, and wherein an outer surface on the first end of the hollow waveguide body has at least one damping means to suppress propagation of electromagnetic waves on the outer surface; and
wherein an end face on the second end of the hollow waveguide body has at least one damping means to suppress propagation of electromagnetic waves on the end face; and wherein
the hollow waveguide body defines a second aperture that extends from the first end of the hollow waveguide body to the second end of the hollow waveguide body to form a second hollow waveguide; and wherein
the at least one damping means is designed and arranged to suppress propagation of electromagnetic waves on the end face and on the outer surface, starting from the first hollow waveguide to the second hollow waveguide.

2. The hollow waveguide assembly as claimed in claim 1 and wherein the at least one damping means suppresses propagation of electromagnetic waves on the end face, and on the outer surface completely starting from the first aperture and/or from the second aperture.

3. The hollow waveguide assembly as claimed in claim 1 and wherein the at least one damping means is arranged running partly annularly, or completely annularly, around at least one of the apertures.

4. The hollow waveguide assembly as claimed in claim 1 and wherein the at least one of the damping means is formed as a recess defined in the end face or in the outer surface.

5. The hollow waveguide assembly as claimed in claim 1 and wherein the at least one of the damping means is an elevation on the end face or an elevation on the outer surface.

6. A waveguide system comprising:
a waveguide assembly; and
a first hollow waveguide assembly, that has a hollow waveguide body; and
a waveguide transition between the waveguide assembly and the hollow waveguide body of the first hollow waveguide assembly, and the waveguide transition is for transmitting an electromagnetic wave between at least one first hollow waveguide of the first hollow waveguide assembly and at least one waveguide of the waveguide assembly, and wherein
the hollow waveguide body has at least one damping means on an end face facing the waveguide assembly, which suppresses propagation of electromagnetic waves on the end face.

7. The waveguide system as claimed in claim 6 and wherein the waveguide assembly is a second hollow waveguide assembly that has a hollow waveguide body, and wherein each of the second hollow waveguide assembly, and the first hollow waveguide assembly, defines a first aperture that extends from a first end of the respective hollow waveguide body to a second end of the respective hollow waveguide body to form a respective first hollow waveguide, and wherein the second hollow waveguide assembly and the first hollow waveguide assembly are positioned relative to one another in such a way that the respective first apertures extend coaxially and the end faces of the respective second ends of the respective hollow waveguide bodies are opposite one another.

8. The waveguide system as claimed in claim 7 and wherein the hollow waveguide body of the second hollow waveguide assembly has at least one damping means on an end face of the hollow waveguide body facing the first hollow waveguide assembly to suppress propagation of electromagnetic waves on the end face of the hollow waveguide body of the second hollow waveguide assembly.

9. The waveguide system as claimed in claim 6 and wherein the hollow waveguide body of the first hollow waveguide assembly and the hollow waveguide body of the second hollow waveguide assembly each define a second aperture and each second aperture extends from the first end of the respective hollow waveguide body to the second end of the respective hollow waveguide body to form a respective second hollow waveguide, which extend coaxially with respect to each other.

10. The waveguide system as claimed in claim 6 and further comprising:
an electric module that has an antenna assembly is positioned and aligned relative to the first hollow waveguide assembly to introduce the electromagnetic wave into at least one of the first hollow waveguide and/or second hollow waveguide of the first hollow waveguide assembly starting from the first end of the hollow waveguide body of the first hollow waveguide assembly.

11. The waveguide system as claimed in claim 6 and wherein the waveguide assembly and the first hollow waveguide assembly form a plug-in connection.

12. A method for data transmission comprising the steps:
providing a hollow waveguide assembly, the hollow waveguide assembly having a hollow waveguide body defining a first aperture extending from a first end of the hollow waveguide body to a second end of the hollow waveguide body to form a first hollow waveguide, and wherein the hollow waveguide body defines a second aperture that extends from the first end of the hollow waveguide body to the second end of the hollow waveguide body to form a second hollow waveguide; and wherein
an outer surface on the first end of the hollow waveguide body has at least one damping means to suppress propagation of electromagnetic waves on the outer surface; and wherein
an end face on the second end of the hollow waveguide body has at least one damping means to suppress propagation of electromagnetic waves on the end face; and wherein
the at least one damping means is arranged to extend, at least one of, partly annularly or completely annularly, around at least one aperture; and wherein
the at least one of the damping means is formed of, at least one of, a recess and/or an elevation defined in at least one of the end face or in the outer surface; and
introducing an electromagnetic wave for transmitting the data into a hollow waveguide defined in the hollow waveguide body.

13. The hollow waveguide assembly as claimed in claim 1 and wherein the at least one damping means suppresses propagation of electromagnetic waves on the end face, and on the outer surface, at least in a circular section, starting from the first aperture and/or from the second aperture.

14. The hollow waveguide assembly as claimed in claim 1 and wherein the at least one damping means is arranged between the first aperture and the second aperture.

15. The hollow waveguide assembly as claimed in claim 1 and wherein the at least one of the damping means is at least one of a groove or a flute.

16. The hollow waveguide assembly as claimed in claim 1 and wherein the at least one of the damping means is at least one of a wall, a sleeve, or a web.
